(19) United States
(12) Patent Application Publication
(10) Pub. No.: US 2014/0179019 A1
(43) Pub. Date: Jun. 26, 2014

(54) Simultaneous Global Thermometry, Barometry, and Velocimetry Systems and Methods

(71) Applicant: University of Washington through its Center for Commercialization, Seatle, WA (US)

(72) Inventors: Dana Dabiri, Brier, WA (US); Gamal-Eddin Khalil, Redmond, WA (US)

(73) Assignee: University of Washington through its Center for Commercialization, Seattle, WA (US)

(21) Appl. No.: 14/084,562

(22) Filed: Nov. 19, 2013

Related U.S. Application Data
(60) Provisional application No. 61/728,127, filed on Nov. 19, 2012.

(51) Int. Cl. G01N 21/64

(52) U.S. Cl. CPC G01N 21/64
USPC 436/172; 427/157

(57) ABSTRACT

Microbeads include small preformed microbead substrates, which may comprise, for example, silica particles having a characteristic dimension less than 2 millimeters. A plurality of luminophores are applied to an exposed surface of the microbead substrates, wherein the luminophores are selected for detecting pressure and/or temperature. A plurality of luminophores absorb light at a predetermined wavelength to transition to an excited state, and they luminesce at different wavelengths when returning to the ground state. The luminescence may be phosphorescence or fluorescence. In some embodiments the microbeads include at least one pressure-sensitive luminophore, at least one temperature-sensitive luminophore, and at least one reference luminophore that is neither pressure-sensitive nor temperature-sensitive. In some embodiments the microbeads are configured for use in digital particle image velocimetry.

### CROSS-REFERENCES TO RELATED APPLICATIONS

This application claims the benefit of Provisional Application No. 61/728,127, filed Nov. 19, 2012, the entire disclosure of which is hereby incorporated by reference herein.

### STATEMENT OF GOVERNMENT LICENSE RIGHTS

This invention was made with Government support under award number 0929864 awarded by the National Science Foundation. The Government has certain rights in the invention.

### BACKGROUND

Arguably, one of the most important yet least understood problems in the field of classical mechanics is turbulence. Although the governing equations have been known since 1845, no theory of turbulence has emerged that can be applied universally to predict turbulent flow behavior, despite a century of study. Sir Horace Lamb best summarized in 1932 today's researcher's frustration stating, “I am an old man now, and when I die and go to Heaven there are two matters on which I hope enlightenment. One is quantum electro-dynamics and the other is turbulence of fluids. About the former, I am really rather optimistic.”

In order to understand the difficulty with turbulence, it is necessary to briefly lay out the relevant equations. The equations describing the motion of a fluid of constant density and small temperature fluctuations are:

$$\frac{\partial {u}_{i}}{\partial {x}_{i}} = 0 \\ \frac{\partial {u}_{i}}{\partial t} + {u}_{j} \frac{\partial {u}_{i}}{\partial {x}_{j}} = - \frac{1}{ρ} \frac{\partial p}{\partial {x}_{i}} + v \frac{{\partial }^{2} {u}_{i}}{\partial {x}_{j}^{2}} \\ \frac{\partial θ}{\partial t} + {u}_{j} \frac{\partial θ}{\partial {x}_{j}} = κ \frac{{\partial }^{2} θ}{\partial {x}_{j}^{2}} \qquad ( 1 )$$

where uᵢ is the instantaneous local velocity in the xᵢ direction, ρ is density, θ is instantaneous local temperature, p is instantaneous local pressure, v is kinematic viscosity, and κ is thermal diffusivity. If the Reynolds number of the flow is large enough that the flow fluctuates randomly or unpredictably in time, it then is considered turbulent.

This system of second order partial differential equations is not amenable to easy solution. Modeling, most often based on hypotheses and ad hoc assumptions, is always required to computationally solve these equations, and analytical solutions are limited to very restricted cases.

Solving the equations directly using numerical procedures requires that all the relevant length and time scales are resolved in the numerical simulation. Unfortunately, the spatial numerical resolution required in a particular direction is approximately proportional to the ratio of the length of the energy-containing eddies, l, to the Kolmogorov length scale, η, where l/η≈Re3/4=(ul/v)^{3/4}, and u is an rms velocity scale, and for all three spatial dimensions, the resolution goes as ˜(R^{3/4})³. It can also be shown that the temporal resolution goes as √R^{3/4}. Therefore, the required number of grid points necessary to resolve turbulent flows within a space-time continuum goes as Re³. Because of this strong dependence on the Reynolds number, only lower Reynolds number flows can be considered for direct numerical simulation with present computational capabilities.

Consequently one is typically left with no choice but to work with the time-averaged Navier-Stokes equations, which requires finding and testing turbulence models that properly and accurately represent the averaged pressure-strain rate term, the pressure-velocity terms, the turbulent heat flux, and the Reynolds stress.

Unfortunately, no experimental method at present exists for the simultaneous determination of the turbulent fluctuation terms u̅′̅ᵢ̅u̅′̅ⱼ̅, the Reynolds stress term, u̅′̅ᵢ̅p̅′̅, the pressure-velocity term, [symbol] u′ᵢp′ [symbol] , the pressure-strain-rate, and θ̅′̅u̅′̅ⱼ̅, the turbulent heat flux term. The experimental study and measurement of these terms would allow new models to be developed that are based on experimentally-determined physics.

In general, digital particle image velocimetry (“DPIV”) is a method for measuring time-dependent velocity fields in a fluid using image acquisition techniques. The flow field is seeded with small reflective particles, and the flow field is illuminated with a bright light, typically a bright laser light sheet. Images of the seed particles' reflections are captured with an imaging system. Through known image processing techniques, the velocity field of the fluid may be accurately inferred from the motion of the particles. Conventional DPIV provides velocimetry in the flow field. For thermometry and barometry we propose to use particles that are configured to respond to both temperature and pressure, such that the time-varying and spatially-varying velocity, pressure and temperature in a flow field may be experimentally determined.

Pressure-sensitive paint (“PSP”) is known in the art, typically made of an oxygen-sensitive fluorescent or phosphorescent molecule that is incorporated into an oxygen-permeable polymer binder and dissolved in a volatile solvent to form a paint that can be easily applied to surfaces. Exposing the luminescent molecule, or luminophore, to light of an appropriate wavelength places the luminophore in an excited state. The luminophore will release its energy over time, primarily by either emitting photons of a known wavelength, or by transferring energy to diatomic oxygen molecules (known as luminescence quenching). A higher concentration of oxygen surrounding the luminophore results in higher energy transfer to oxygen, rather than emission of photons. Therefore, the light emission from the luminophore may be used to measure the local concentration of oxygen. Because the oxygen concentration of air is proportional to pressure, quantitatively measuring changes in the luminophore intensity yields a measure of the pressure.

PSP has allowed for the non-intrusive global measurement of pressure on aerodynamic surfaces. Fast-responding PSP has been used in unsteady aerodynamic applications, such as airflow over rotor blades. Conventional PSPs contain oxygen-sensitive molecules that are held within an oxygen permeable polymer binder. When illuminated with absorbing wavelengths, the excited molecules release part of their energy as photons. However, surrounding oxygen molecules can absorb some of the emitted photons.

For example, in a typical system a surface may be painted with a PSP. The oxygen-sensitive molecules in the PSP are substantially in a ground state until they are excited by absorbing a photon from an excitation illumination source. The excited electrons return to the ground state by radiative processes (“luminescence”) and by non-radiative processes. The radiative processes include fluorescence (e.g., luminescence by direct transition from an excited state to the ground state) and phosphorescence (e.g., luminescence after intersystem crossing to a triplet system from an excited state to the ground state).

A significant non-radiative process is luminescence quenching by oxygen, wherein surrounding oxygen molecules absorb some of the emitted photons. Luminescent quenching is proportional to the local concentration of oxygen. Hence, the luminescence observed is inversely proportional to the oxygen concentration within the surrounding atmosphere. The concentration of oxygen in the air is proportional to pressure, and therefore PSPs can be used to accurately measure pressure. In a typical implementation, one or more light sources having the appropriate wavelengths illuminate the PSP-painted surface, thereby exciting luminophores in the PSP. Charge-coupled device (CCD) cameras are used to measure the light emissions from the PSP-painted surfaces. This methodology has been successfully used in wind-tunnel applications and is now commercially available.

The present inventors with others at the University of Washington investigated the use of polystyrene microspheres and porous silicon dioxide microspheres, doped with dual luminophores to produce self-referencing particles capable of measuring pressure fields within a gas phase flow. See, “Development and characterization of fast responding pressure sensitive microspheres,” Kimura et al., Review of Scientific Instruments 79, 074102 (2008), which is hereby incorporated by reference in its entirety. However, the response times for the microspheres to changes in the pressure field was longer than what would be desirable for measuring a rapidly evolving unsteady flow.

A state-of-the-art imaging-based measurement method and media are proposed that provide detailed short-response time, simultaneous measurements of time-evolving velocity and pressure and/or temperature fields. The measurement system is based on digital particle image velocimetry using tracer particles that enable pressure and temperature measurements. The disclosed microbeads have very short response times, making them suitable for monitoring unsteady and rapidly evolving flow fields.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A microbead for measuring temperature and/or pressure with short response times includes a preformed microbead substrate that is loaded with a plurality of luminophores. A first luminophore and a second luminophore are applied to the exposed surface of the microbead substrate. The second luminophore is pressure-sensitive or temperature-sensitive. The first and second luminophores absorb light at a predetermined wavelength, and luminesce at different wavelengths.

In an embodiment, the first luminophore is a non-pressure-sensitive reference luminophore, and the second luminophore is pressure-sensitive. For example in some embodiments the pressure-sensitive luminophore is platinum octaethylporphine, platinum meso-tetra(pentafluorophenyl)porphine, and bis(3,5-difluoro-2-(2-pyridyl)phenyl-(2-carboxypyridyl))iridium III.

In some embodiments, the pressure-sensitive luminophore is an organometallic complex. For example, in some embodiments the pressure-sensitive luminophore is selected from platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, ruthenium tris(4,7-diphenyl-1,10-phenanthroline)Cl2, osmium tris(bathophenanthroline)Cl2, bis(3,5-difluoro-2-(2-pyridyl)phenyl-(2-carboxypyridyl))iridium, and iridium tris(2-(beilzo[b]thiopliene-2-yl)pyridine).

In some embodiments the pressure-sensitive luminophore is an organic complex. For example, in some embodiments the pressure-sensitive luminophore is selected from coproporphyrin I tetramethyl ester, pyrene, acridine orange, and pyrenebutyric acid.

In an embodiment the first luminophore is a temperature-insensitive luminophore and the second luminophore is a temperature-sensitive luminophore.

In an embodiment the first luminophore is a non-pressure-sensitive reference luminophore, and the second luminophore is a pressure-sensitive luminophore, and a third luminophore is applied to the microbead substrate that is a temperature-sensitive luminophore. For example, in some embodiments the temperature-sensitive luminophore is selected from europium thenoyltrifluoroacetonate, rhodamine base B, Eu(tta)3DEADIT, coumarin 485, and 4-pyrazolinylnaphthalic anhydride. In some embodiments the pressure-insensitive luminophore is one of meso-tetra(pentafluorophenyl)porphine, magnesium meso-tetra(pentafluoro-phenyl) porphine, coumarin 500, aluminum phthalocyanine tetrasulfonate, silicon octaethylporphine, fluorescein, rhodamine 6G, and sulforhodamine 101.

In some embodiments the microbead substrate is a silica particle. In some embodiments the microbead substrate is one of a silicon dioxide particle, a titanium dioxide particle, an aluminum oxide particle, a calcium carbonate particle, a zinc oxide particle, a zirconium dioxide particle, and a hollow glass sphere. In some embodiments the microbead substrate is microporous or mesoporous.

A method of making microbeads includes (i) fabricating or obtaining microbead substrates having a characteristic dimension less than two millimeters, (ii) preparing a fluid mixture that includes a plurality of luminophores that absorb energy at a predetermined wavelength, wherein the emission characteristics of at least one of the luminophores is sensitive to pressure or temperature, (iii) immersing the microbead substrates in the mixture, (iv) removing the microbead substrates from the mixture such that a portion of the luminophores in the mixture are retained on the microbead substrates, and rinsing the luminophore-retaining microbead substrates.

In an embodiment the plurality of luminophores include at least one temperature-sensitive luminophore and at least one pressure-sensitive luminophore.

In some embodiments the microbead substrates are immersed for an extended period of time greater than about an hour. In some embodiments the fluid mixture is stirred while the microbeads are immersed therein.

In some embodiments the microbead substrates are silicon dioxide particles, titanium dioxide particles, aluminum oxide particles, calcium carbonate particles, zinc oxide particles, zirconium dioxide particles, or hollow glass spheres.

In some embodiments, the pressure-sensitive luminophores may include one or more of platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, coproporphyrin I tetramethyl ester, pyrene, acridine orange, ruthenium tris(4,7-diphenyl-1,10-phenanthroline)Cl2, osmium tris(bathophenanthroline)Cl2, pyrenebutyric acid, bis(3,5-difluoro-2-(2-pyridyl)phenyl-(2-carboxypyridyl)iridium, and iridium tris(2-(beilzo[b]thiopliene-2-yl)pyridine).

In some embodiments the temperature-sensitive luminophore is one or more of europium thenoyltrifluoroacetonate, rhodamine base B, Eu(tta)3DEADIT, coumarin 485, and 4-pyrazolinylnaphthalic anhydride.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates emission spectra detected for four different microbead configurations excited with a 365 nm LED, and showing peaks at the emission wavelengths of the loaded dyes (dye B, dye E, and dye H); and

FIG. 2 shows plots of the pressure response time for pressure-sensitive microbeads fabricated in accordance with the two-step process disclosed herein, and compared to the response time for microbeads formed by prior art one-step methods, wherein the microbeads are excited with light from a continuous 405 nm laser.

### DETAILED DESCRIPTION

Microbeads, and methods for making microbeads, having short-reaction-time pressure-sensitive and/or temperature sensitive characteristics will now be disclosed. The disclosed microbeads may be suitable for use in digital particle image velocimetry (“DPIV”) for monitoring the unsteady flow fields, and simultaneously detecting and monitoring the pressure and/or the temperature throughout the flow field. As used herein, microbeads are defined to be particles having a diameter or other characteristic dimension less than 2 mm. In some applications the microbeads may have a characteristic dimension less than about 30 microns. The disclosed microbeads include a plurality of luminophore dyes on microbead substrates. The microbeads are illuminated with light at a wavelength suitable to excite the luminophores, and the radiation emitted by the luminophores as they return to the ground state is measured. Novel microbeads disclosed herein have a response time short enough to be useful for monitoring rapidly evolving flow fields.

In “Dual luminophore polystyrene microspheres for pressure-sensitive luminescent imaging,” Kimura et al., Meas. Sci. Technol. 17(6), 1254, (2006), which is hereby incorporated by reference, the present inventors disclose dual luminophore polystyrene microbeads that allows for self-referencing pressure-sensitive microbeads.

Disclosed herein are fast-reacting pressure-sensitive and temperature-sensitive microbeads. In particular, some of the disclosed embodiments are believed to be the first microbeads able to indicate pressure, temperature, and velocity simultaneously in a flow field.

As discussed above, in applications involving unsteady flows it is important that the pressure- and/or temperature-sensitive microbeads have a response time that is short enough to capture changes occurring in the flow field. In particular, in unsteady flows it is desirable that the microbeads respond sufficiently fast to capture rapid changes in pressures and temperatures in the flow field.

The response time for prior art PSPs has been described as dependent on three important parameters: the luminescent lifetime of the luminophore, the oxygen diffusivity of the matrix layer, and the thickness of the matrix layer. Typically, the scope of the luminophores' lifetime expands from 1 μs to 50 μs. The estimation of the 99% rise time of a thin PSP layer can be expressed as:

$${τ}_{99 \%} = \frac{12 * {L}^{2}}{{π}^{2} * D}$$

$$and$$

$${τ}_{99 \%} = \frac{3 * {d}^{2}}{4 * {π}^{2} * D}$$

for a microbead, where L is the thickness of the PSP layer, d is the diameter of the bead, and D is the oxygen diffusion coefficient of the matrix being used. Hence, to develop a fast responding microbead, a compromise must be made between the thickness of the layer and the oxygen diffusion coefficient. The response times for 2 μm diameter polystyrene microbeads are estimated to range from 9.8 ms to 27.6 ms, which would be too slow for desired applications, such as measuring pressure changes in turbulent flows.

Prior art methods for fabricating pressure-sensitive microbeads have formed the microbeads in a single step, with the luminophores and a matrix material (e.g., styrene) premixed prior to forming the microbeads. A new two-step fabrication method is disclosed herein wherein microbead substrates are first formed (or purchased) and then luminophores are applied to the exposed surface of the microbead substrate.

### Example 1

### Pressure- and Temperature-Sensitive Microbeads (“TPSBeads”)

Synthesis of silica microbeads loaded with different dyes is accomplished using a two-step method comprising, (i) fabrication of a microbead substrate, and (ii) loading dyes onto the microbead substrate:

Materials for the microbead substrate:
Cetyltrimethylammonium bromide (“CTAB”)
Ammonium hydroxide (NH₃.H₂O, 28% NH₃ in H₂O)
Tetraethyl orthosilicate (“TEOS”)
Methanol
Ethanol
Deionized water with a resistivity of 18.2 MΩ cm

These materials are used to produce mesoporous or microporous silica microbead substrates per the synthesis methods described below, where the mesopores/micropores are estimated to be 1-2 nm in size. The CTAB molecules serve as templates for the generation of these mesopores during the synthesis process.

In this exemplary embodiment the microbead substrates are silica microbeads formed using a seed-mediated process. In a typical synthesis of the microbead substrate, 100 mg of CTAB, 40 ml of methanol, 7.5 ml of water, and 3 ml of ammonium hydroxide were placed in a 100 ml flask, followed by the introduction of 25 μl of TEOS to generate primary silica seeds. After the reaction was proceeded for 1.5 hours, 2.4 ml of TEOS was injected into the solution at the rate of 0.4 ml/h using a syringe pump to start the growth. The reaction was allowed to proceed at room temperature under magnetic stirring for 24 hours. The resultant mesoporous silica microbeads were collected by centrifugation and washed with ethanol three times. The products were redispersed in 5 ml of ethanol for further use.

In a similar, related embodiment, larger size silica microbeads were purchased pre-fabricated, and used as the microbead substrate. The purchased microbead substrate were √14 μm in diameter hollow glass spheres (Sphericel 110P8, from Potters Industries), which were similarly loaded with dyes as described below. The synthesized microbead substrate results are identified herein with an asterisk, and the purchased microbead substrate results are shown without an asterisk.

Other exemplary particles or microbead substrate materials include, silicon dioxide (e.g., silica gel, fumed silica, etc.), titanium dioxide, aluminum oxide, calcium carbonate, zinc oxide, zirconium dioxide, and other ceramic microspheres.

Dye Loading

A number of different sets of microbeads were fabricated using the microbead substrates. The microbead substrates were loaded with up to three different luminescent dyes, each dye performing a different function.

The first dye is selected from a family of pressure-sensitive dyes that includes (i) platinum octaethylporphine (dye A), (ii) platinum meso-tetra(pentafluorophenyl)porphine (dye B), and (iii) bis(3,5-difluoro-2-(2-pyridyl)phenyl-(2-carboxypyridyl))iridium III (dye D). The emission wavelengths of these pressure-sensitive dyes are 650 nm, 650 nm, and 500 nm, respectively.

The second dye is a reference dye, for example (i) Coumarin 500 (dye H) or (ii) magnesium meso-tetra(pentafluorophenyl)porphine (dye J). The emission wavelengths of these reference dyes are 530 nm and 650 nm, respectively. The emission intensities of these reference dyes are insensitive to pressure and temperature changes.

The third dye is a temperature sensitive dye, for example europium thenoyltrifloroacetonate (dye E), which has a 615 nm emission wavelength.

Although in these examples one dye from each category (pressure-sensitive, temperature-sensitive, and reference) were selected, it is contemplated that more than one dye from any one or more of the categories may alternatively be used. For example, a first pressure-sensitive dye may be more effective at lower pressures or lower temperatures, and a second pressure-sensitive dye may be more effective at higher pressures or higher temperatures. Both of the dyes may be used, allowing the user to use the results from both luminophores, or selecting one or the other based on the local temperature and/or pressure.

For loading dyes onto the microbead substrates, selected combinations of dyes with specified amounts for each dye, were dissolved in 1.5 ml of acetone at room temperature, and then introduced into 1.5 ml of fabricated or purchased microbead substrates. The mixture was ultrasonically dispersed for 1 hour and then magnetically stirred overnight. The final products were collected by centrifugation and washed with water three times.

Several combinations using different dye concentrations were synthesized. For example, microbead substrates were loaded with selected ratios of dye B, dye E, and dye H (referenced above). The pressure- and temperature-sensitive microbeads (“TPSBeads”) will sometimes be referred to herein by the dye identifiers referenced above. For example, a “BEH microbead” (or “Silica BEH”) refers to a microbead (or silica microbead) loaded with dyes B, E, and H.

Over 60 samples of microbeads were evaluated for spectral characteristics and response time to pressure jumps. Test samples were made by drop-casting 100 μl of water suspension (≈10% solids) of the microbeads onto the surface glass slide of 3 cm by 1 cm. The samples were dried in an oven set at 70° C.

Other exemplary pressure-sensitive dyes suitable for the present invention include: platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, coproporphyrin I tetramethyl ester, pyrene, acridine orange, ruthenium tris(4,7-diphenyl-1,10-phenanthroline)Cl₂, osmium tris(bathophenanthroline)Cl₂, pyrenebutyric acid, bis(3,5-difluoro-2-(2-pyridyl)phenyl-(2-carboxypyridyl)iridium, and iridium tris(2-(beilzo[b]thiopliene-2-yl)pyridine).

Other exemplary temperature-sensitive dyes suitable for the present invention include: europium thenoyltrifluoroacetonate, rhodamine base B, Eu(tta)3DEADIT, coumarin 485, and 4-pyrazolinylnaphthalic anhydride.

Other exemplary reference dyes suitable for the present invention include, meso-tetra(pentafluorophenyl)porphine, magnesium meso-tetra(pentafluorophenyl)porphine, coumarin 500, aluminum phthalocyanine tetrasulfonate, silicon octaethylporphine, fluorescein, rhodamine 6G, and sulforhodamine 101.

Shock Tube Test

A shock tube was used to measure the response time of the TPSBeads to rapid pressure jumps. Other techniques for response time that have been studied though the shock tube presented a reliable method for determining response times of pressure rises at the microsecond scale. The shock tube setup consisted of a square aluminum tube with walls 0.64 cm thick, with a cross section of 3.9 cm by 3.9 cm. The shock tube was assembled from two main sections, a 3.1 m long expansion (driver) chamber, and a 1.8 m long compression (driven) chamber. A diaphragm was positioned at the connection between the two sections that burst when the pressure difference between both chambers was high enough, causing a shockwave to propagate down the compression section.

The diaphragm was made of a plastic paraffin film (e.g., Parafilm®) and the thickness was varied by modifying the number of layers of film. A configuration of six layers of film was used as the pressure decreased from 100 kPa to 4 kPa, a pressure ratio obtained of 1:25.

The pressure difference was established in one of two ways: a vacuum pump was used to directly pump out the air in the compression chamber or used to generate low pressure in a large tank, which was then connected to the compression chamber. The motivation for using the latter was to reduce the wait time for the vacuum pump to lower the pressure directly in the compression section. Two 1.9 cm by 3.8 cm test windows, on which the microbeads test samples were mounted, were positioned 0.58 m downstream of the diaphragm. Samples were placed on this top window of the shock tube, oriented face down, in order to reduce the optical interference of the shockwave with the illuminating samples, but still maintain a direct face on the passing shockwave.

Unsteady and steady pressures were measured 0.12 m downstream of the test window using a high sensitivity dynamic pressure sensor with a 90% rise time of 2 μs attached to a power supply coupler for the unsteady pressure measurements. For the steady pressure measurements, a conventional pressure transducer was used. The pressure transducers were positioned in the tube flush with the walls to not interfere with the flow. The stated accuracy of the steady pressure transducers were 0.25% of the full scale.

Luminescence and Data Acquisition

The detection system comprises a 405 nm continuous laser light used to excite the microbeads. The test sample was attached to the top window such that the microbeads were facing down in direct contact to the shock wave. The light emitted by the test sample was focused on a photomultiplier tube (“PMT”) fitted with a band-pass filter at the appropriate wavelength. The PMT had a 2.2 μs rise time and a gain of 107 for an applied voltage of 1000 V. Additionally, a band-pass filter was positioned in front of the laser to reject any other lines. The data from each transducer is processed by a computer system using conventional data acquisition and analysis hardware and software, as are well known in the art.

After the sample was placed onto the window, the vacuum pump pumped down the downstream section of the shock tube until the diaphragm burst; all while the pressure and intensity data were being recorded. The data obtained was exported, plotted, and processed to calculate the response time of the tested microbeads based on a 63.2% and 90% rise time of the intensity change. It is useful to characterize the response time as a percent increase in rise time of the intensity change rather than multiple time constants associated with the multi-exponential models, wherein a 90% rise time is a suitable representation of the response time.

Emission Spectra and Initial Results

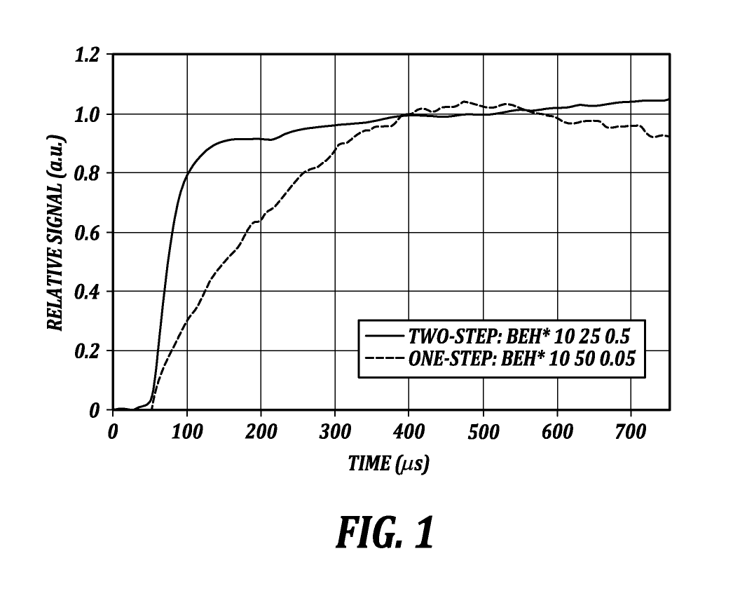

The emitted light spectrums of the TPSBeads were examined to determine whether the particular samples of TPSBeads were sufficiently illuminating at the wavelengths of each dye. An example of detected emission spectra from several different TPSBeads is illustrated in FIG. 1 (simplified for presentation), which shows the spectral response of several TPSBeads fabricated using the two-step method described above. Results for four particular TPSBeads are shown, using dye B, E, and H, in different dye ratios, as indicated in FIG. 1. In order to demonstrate that our procedures in determining response time were sufficient, initial tests of silica BEH* microbeads (microbeads with purchased glass microbead substrate, and dyes B, E, and H) were performed and the signals for each of the three dyes incorporated into the TPSBeads was captured. The peaks are at 530 nm (dye H), 615 nm (dye E), and 650 nm (dye B).

A table of the testing and response time results is presented in Table I for a number of microbeads made using the two-step method described above. For comparison, response times for several silica microbeads fabricated using a corresponding one-step method are also shown. The range of response times at 90% rise time due to the shock wave spreads from 26 μs to 268 μs. Even longer response times were found using polystyrene microbeads fabricated using a one-step method.

Table I shows that the two-step fabrication method provides greater consistency in the response time and consistently short response times. The BEH* microbeads fabricated using the one-step method have average (n=4) 63.2% and 90% response time values of 114 μs and 204 μs, respectively, with standard deviations of 69 μs and 117 μs. However, the BEH and BEH* (both commercial microbead substrate and the microbead substrate synthesized during the fabrication process) fabricated using the two-step method has respective averages of 41 μs and 79 μs, with standard deviations of 25 μs and 66 μs.

Therefore, the average response time using the two-step fabrication method was approximately a third of that using the one-step method, with significantly lower deviations. Lastly, the silica BE microbeads were the final and best effort to create microbeads using the two-step method and resulted in the fastest response times, with an averaged 63.2% and 90% rise time of 18 μs and 29 μs, respectively, with 2.8 μs and 4.2 μs standard deviations, respectively.

TABLE I
Calculated response times for samples tested in shock tube facility

| | | | Response Times (μs) | |
|---|---|---|---|---|
| Sample | Method | Dyes Ratio | 63.2% | 90% |
| Silica BH* | Two Steps | 10:0.5 | 26 | 60 |
| Silica BEH | Two Steps | 5:25:0.5 | 24 | 44 |
| Silica BEH* | Two Steps | 5:25:0.5 | 26 | 50 |
| Silica BEH* | Two Steps | 10:25:0.5 | 30 | 52 |
| Silica BEH* | Two Steps | 10:25:0.5 | 56 | 80 |
| Silica BEH* | Two Steps | 5:25:0.25 | 24 | 44 |
| Silica BEH* | Two Steps | 10:25:5 | 40 | 84 |
| Silica BEH* | Two Steps | 5:25:0.5 | 54 | 78 |
| Silica BEH* | Two Steps | 5:10:0.5 | 64 | 90 |
| Silica BEH* | Two Steps | 5:15:1 | 28 | 42 |
| Silica BEH | Two Steps | 15:20:2 | 46 | 78 |
| Silica BEH | Two Steps | 10:20:20 | 28 | 62 |
| Silica BEH* | Two Steps | 5:15:1 | 24 | 52 |
| Silica BEH* | Two Steps | 7:250:2 | 24 | 52 |
| Silica BEH* | Two Steps | 10:20:2 | 30 | 64 |
| Silica BEH | Two Steps | 10:20:1 | 118 | 310 |
| Silica DJ* | Two Steps | 10:1 | 150 | 462 |
| Silica BE | Two Steps | 10:20 | 16 | 26 |
| Silica BE | Two Steps | 20:20 | 20 | 32 |
| Silica BEH* | One Step | 5:50:0.05 | 20 | 28 |
| Silica BEH* | One Step | 10:50:0.05 | 180 | 268 |
| Silica BEH* | One Step | 10:50:0.05 | 144 | 266 |
| Silica BEH* | One Step | 10:50:0.5 | 112 | 252 |

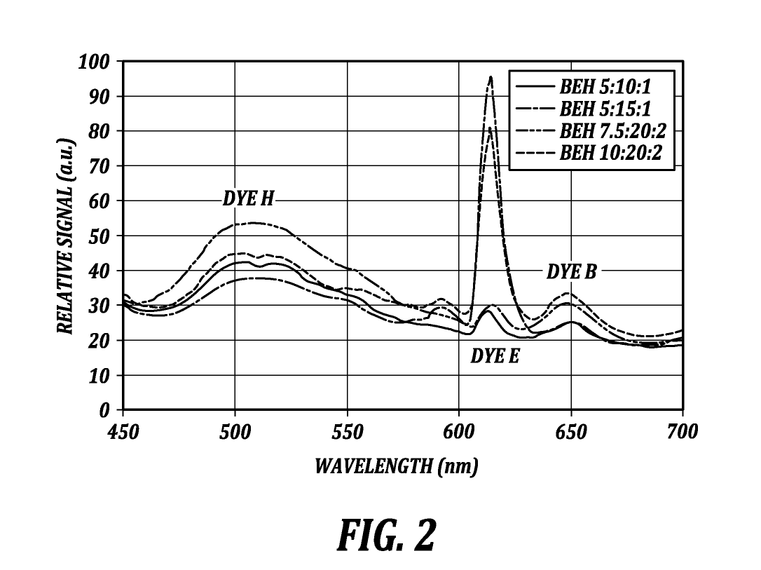

FIG. 2 presents a plot of a one-step fabrication method silica microbeads test and a two-step fabrication method test further showing the improvement in the response time that is attributable to the two step fabrication method disclosed herein. Furthermore, the microbeads dye loading did not seem to affect the response time, as Table I shows no distinct relationship between the dye loading and better response times.

One additional investigation involved testing some of the microbead samples using a different illumination pattern. Instead of illuminating the test sample with a laser spot that ranged from 5 mm to 10 mm in diameter, a 1 mm thick laser line was created, using a cylindrical lens, to illuminate the test sample perpendicular to the direction of the shock propagation. As the shock transit time over the laser line is much quicker than over the laser spot, the motivation for this change was to investigate whether the measured response time would be more precise. The results of these tests did not show improvements in the response time, therefore suggesting that the laser line illumination was not necessary, and that a laser spot was sufficient.

The response times of different pressure-sensitive multi-dyed microbeads to passing shock waves were measured. The silica-based microbeads exhibited response times ranging between 26 μs and 462 μs. The majority of the silica-based samples showed adequate response times for use in unsteady flow investigations. The particular microbeads tested exhibited high signal-to-noise ratios as well as high sensitivity while maintaining their fast response times. The data revealed that the most significant contribution to response time is the fabrication method of the microbeads, particularly since the two step method of fabrication consistently produced fast responding microbeads. The dye loading of the microbeads showed no correlation to the response times. Therefore, the fabrication and method of incorporating the dyes into the microbeads is the underlying contributor to the response time, not the amount of each dye.

### Example 2

### Procedure for Fabrication

An exemplary procedure for preparing a particular pressure-sensitive microbead in accordance with the present invention includes the following steps:

1. Prepare dye stock solution. For example, mix 10 mg of Pt (II) meso-tetra(pentafluorophenyl)porphine (Dye B) with 15 mL of dichloromethane (DCM) and 10 mL of methanol, taking care that the dye is fully dissolved in the solution.

2. Premix microbead substrate. The preformed and undyed microbeads (microbead substrate) are then premixed with the dye solution. For example, weigh 250 mg of 5 μm aluminum oxide particles and add them to a small bottle. Add 2.5 ml of the dye stock solution into the bottle, and then add 3.5 ml of DCM and 4 ml of methanol into the bottle. The final solution is therefore 1 mg of the dye B with 250 mg aluminum oxide particles dissolved in 5 ml of methanol and 5 ml of DCM.

3. Sonication. For example, the mixed solution is then sonicated for 1 hour.

4. Heat and stirring. For example, pour the solution into a glass flask and insert a stirring magnet. Put the flask into a sand bath and connect the top to the glass heat exchanger tube. The solution is heated and stirred overnight (24 hours). If the solution evaporates too fast, turn down the heater level.

5. Washing out the dye. For example, transfer the solution to a glass centrifuge tube and centrifuge the solution for 5 min. Once this is done, the particles should be in the bottom of the tube and separate out from the dye solution. Remove the dye solution and keep the particles in the tube. Add and mix deionized (DI) water with the particles and repeat the centrifuge step again. Remove the water solution, add fresh DI water and repeat the washing process again. Remove the water until 2-4 ml of water is left in the tube.

6. Make dry sample. For example, use pipette to drop 100 μl sample of water suspension on a glass slide and placed in the oven set at 75° C. for a few minutes to dry the sample.

7. Emission spectrum check. For example, the dried sample luminescence property is measured using Ocean-Optic spectrometer. The sample should produce the 650 nm emission band of dye B when excited at 405 nm. Observe the spectrum response for a go/no go check.

8. Pressure response check. Put the dye into the round pressure chamber and pump down the chamber. Record the spectrum response of the sample at atmospheric and vacuum pressure.

9. Measure the pressure-intensity response.

10. Measure the pressure response time using the shock tube.

It will be appreciated by persons of skill in the art that this is just one exemplary procedure for forming the desired microbeads with multiple luminophore dyes applied to the surface of the particles

### Example 3

### DLPIBTV

Pressure-sensitive microbeads, and in particular TPSBeads provide new capabilities in studying unsteady fluid flows and turbulence. Newer two-dimensional imaging methods, such as DPIV and digital particle image thermometry and velocimetry (DPITV) allow for simultaneous 2D measurements of time-evolving temperature and velocity; however, the present inventors are not aware of any techniques that can simultaneously provide temperature, pressure and velocity measurements in 2D.

The microbeads fabricated as discussed above enable a new experimentation capability, e.g., of simultaneously measuring the time-evolving velocity, pressure and temperature in a fluid region. This new measurement method is referred to as digital luminescent particle image barometry, thermometry, and velocimetry (“DLPIBTV”). Such simultaneous measurements have never been obtained before and will allow for investigations promoting better understanding and modeling of turbulence, acoustics and noise generation, and hydroacoustics of underwater vehicles.

In DPIV fluid velocities are calculated or inferred from particle velocities by monitoring tracer particles seeded in the fluid, e.g., by imaging the test region while illuminating a cross-section of the flow with a pulsed laser sheet. Images are typically acquired at 30 frames per second, with each frame singly exposed. For analysis, acquired frames are analyzed in sequential pairs. An interrogation window, identically located within both images, extracts portions of each image and performs a cross-correlation, thereby producing an average shift of particles within that window. The interrogation window is then systematically marched through the image, producing a 2D vector plot. The velocity information can then be processed further to provide other kinematic properties, such as vorticity, streamlines, and strain rates.

TPSBeads allow the researcher to obtain simultaneous velocity, temperature, and pressure data throughout a given volume.

This capability is accomplished with TPSBeads that contain three luminophores, for example, platinum octaethylporphyrin (“PtOEP”), silicon octaethylporphine (“SiOEP”) and a temperature-sensitive Europium complex such as Eu(III) thenoyltrifluoroacetonate such that PtOEP is affected by the variable oxygen/pressure, the Europium complex is affected by temperature, while SiOEP, functioning as the reference, is sensitive to neither pressure nor temperature.

In this exemplary embodiment, a laser sheet at 355 nm illuminates the desired cross-section of a flow and all the TPSBeads within it. The laser wavelength is selected such that the pressure-sensitive luminophore, the temperature-sensitive luminophore, and the reference luminophores all absorb at the selected wavelength. Three conventional CCD cameras and a 6-axis stage to align these cameras are positioned on opposite sides of the laser sheet. A conventional data acquisition system is used to acquire the data from all three cameras simultaneously.

For an intensity-based method we image the flow with three cameras. The bottom camera images the flow from one side of the laser sheet through a pressure filter, i.e., 650 nm band pass filter for PtOEP, so as to capture the pressure sensitive luminescence. The second and third cameras image the flow from the opposite sides of the laser sheet. Both of these cameras image the same area using an image splitter. Of these two cameras, one images through a reference filter, i.e., 580 bandpass filter, allowing for capture of the TPSBeads' SiOEP fluorescence, while the other camera images through a temperature filter, i.e., 615 nm bandpass filter for Eu(D2)₃P, allowing for capture of the temperature luminescence.

The selected laser wavelength is 355 nm and excite the TPSBeads within the laser sheet. The luminescence of the reference dye (e.g., SiOEP) is within 6 ns, which would therefore make its images ideal for DPIV processing in order to obtain velocity measurements. Note that the pressure and temperature (e.g., PtOEP & Eu(D2)3P) luminescence is longer, therefore not making them suitable for velocimetric measurements. For each laser pulse, each of the pressure and temperature images for that particular frame is ratioed against the reference image to derive pressure and temperature measurements. Therefore, the data rate for pressure and temperature measurements is twice that of the velocity measurements. The advantage of this setup is that the pulse separation can be varied to accommodate flows of various speeds, without restricting the ability to measure pressure, temperature, or velocity.

For a lifetime-based method, the flow is imaged with two cameras. A pressure detection camera images the TPSBeads from one side of the laser sheet, while a temperature detection camera will image the TPSBeads from the opposite side of the laser sheet. Each of these cameras have their appropriate band pass filters in front of them in order to ensure acquisition of images relevant to the particular dyes being used. Unlike the intensity-based method, in this approach, sequential images are ratioed to obtain pressure and temperature results. DPIV processing methods can also be used on these sequential images to obtain velocity information. However, since these image pairs inherently have a very short separation, the lifetime-based method is not optimal for very high speed flows.

While illustrative embodiments have been illustrated and described, it will be appreciated that various changes can be made therein without departing from the spirit and scope of the invention.

The embodiments of the invention in which an exclusive property or privilege is claimed are defined as follows:

1. A microbead comprising:
a preformed microbead substrate having a characteristic transverse dimension of less than two millimeters; and
a first luminophore and a second luminophore, wherein the first and second luminophores are applied to an exposed surface of the preformed microbead substrate, and wherein the second luminophore is selected for detecting pressure or temperature;
wherein the first and second luminophores absorb light at a predetermined wavelength, the first luminophore luminesces at a first wavelength, and the second luminophore luminesces at a second wavelength that is different from the first wavelength.

2. The microbead of claim 1, wherein the first luminophore is a pressure-insensitive reference luminophore and the second luminophore is a pressure-sensitive luminophore.

3. The microbead of claim 2, wherein the pressure-sensitive luminophore comprises one of:
platinum octaethylporphine, platinum meso-tetra(pentafluorophenyl)porphine, and bis(3,5-difluoro-2-(2-pyridyl)phenyl-(2-carboxypyridyl))iridium III.

4. The microbead of claim 2, wherein the pressure-sensitive luminophore comprises an organometallic complex.

5. The microbead of claim 4, wherein the organometallic complex comprises one of platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, ruthenium tris(4,7-diphenyl-1,10-phenanthroline)Cl₂, osmium tris(bathophenanthroline)Cl₂, bis(3,5-difluoro-2-(2-pyridyl)phenyl-(2-carboxypyridyl))iridium, and iridium tris(2-(beilzo[b]thiopliene-2-yl)pyridine).

6. The microbead of claim 2, wherein the pressure-sensitive luminophore comprises an organic complex.

7. The microbead of claim 6, wherein the organic complex comprises one of coproporphyrin I tetramethyl ester, pyrene, acridine orange, and pyrenebutyric acid.

8. The microbead of claim 1, wherein the first luminophore is a temperature-insensitive reference luminophore, and the second luminophore is a temperature-sensitive luminophore.

9. The microbead of claim 2, wherein the microbead further comprises a third luminophore that is temperature-sensitive, such that an emission characteristic of the third luminophore is related to a temperature at the luminophore.

10. The microbead of claim 9, wherein the temperature-sensitive luminophore comprises europium thenoyltrifluoroacetonate.

11. The microbead of claim 9, wherein the temperature-sensitive luminophore comprises one of: europium thenoyltrifluoroacetonate, rhodamine base B, Eu(tta)3DEADIT, coumarin 485, and 4-pyrazolinylnaphthalic anhydride.

12. The microbead of claim 9, wherein the reference luminophore comprises one of: meso-tetra(pentafluorophenyl)porphine, magnesium meso-tetra(pentafluoro-phenyl)porphine, coumarin 500, aluminum phthalocyanine tetrasulfonate, silicon octaethyl-porphine, fluorescein, rhodamine 6G, and sulforhodamine 101.

13. The microbead of claim 9, wherein the pressure-sensitive luminophore comprises one of: platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, coproporphyrin I tetramethyl ester, pyrene, acridine orange, ruthenium tris(4,7-diphenyl-1,10-phenanthroline)Cl₂, osmium tris(bathophenanthroline)Cl₂, pyrenebutyric acid, bis(3,5-difluoro-2-(2-pyridyl)phenyl-(2-carboxypyridyl)iridium, and iridium tris(2-(beilzo[b]thiopliene-2-yl)pyridine)

14. The microbead of claim 1, wherein the preformed microbead substrate comprises silica.

15. The microbead of claim 1, wherein the preformed microbead substrate comprises one of: a silicon dioxide particle, a titanium dioxide particle, an aluminum oxide particle, a calcium carbonate particle, a zinc oxide particle, a zirconium dioxide particle, and a hollow glass sphere.

16. The microbead of claim 15, wherein the preformed microbead substrate is microporous or mesoporous.

17. A method of making microbeads comprising:
fabricating or obtaining a plurality of microbead substrates having a characteristic dimension less than 2 millimeters;
preparing a fluid mixture comprising a plurality of luminophores that absorb energy at a predetermined wavelength, wherein at least one of the plurality of luminophores has an emission characteristic that is sensitive to pressure or temperature;
immersing the microbead substrates in the fluid mixture;
removing the microbead substrates from the fluid mixture, wherein the removed microbead substrates retain some of the plurality of luminophores; and
rinsing the luminophore-retaining microbead substrates.

18. The method of claim 17 wherein the plurality of luminophores comprise at least one temperature-sensitive luminophore and at least one pressure-sensitive luminophore.

19. The method of claim 18 wherein the microbead substrates are immersed in the fluid mixture for an extended period of time longer than about an hour.

20. The method of claim 19, further comprising stirring the fluid mixture during the extended period of time.

21. The method of claim 17, wherein the microbead substrates comprise: silicon dioxide particles, titanium dioxide particles, aluminum oxide particles, calcium carbonate particles, zinc oxide particles, zirconium dioxide particles, or hollow glass spheres.

22. The method of claim 18 wherein the pressure-sensitive luminophore comprises one of: platinum octaethylporphine, platinum meso-tetra(pentafluorophenyl)porphine, platinum tetra(pentafluorophenyl)porpholactone, platinum tetrabenztetraphenylporphine, palladium meso-tetra(pentafluorophenyl)porphine, coproporphyrin I tetramethyl ester, pyrene, acridine orange, ruthenium tris(4,7-diphenyl-1,10-phenanthroline)Cl₂, osmium tris(bathophenanthroline)Cl₂, pyrenebutyric acid, bis(3,5-difluoro-2-(2-pyridyl)phenyl-(2-carboxypyridyl)iridium, and iridium tris(2-(beilzo[b]thiopliene-2-yl)pyridine).

23. The method of claim 18, wherein the temperature-sensitive luminophore comprises one of: europium thenoyltrifluoroacetonate, rhodamine base B, Eu(tta)3DEADIT, coumarin 485, and 4-pyrazolinylnaphthalic anhydride.
